(19) United States
(12) Patent Application Publication
(10) Pub. No.: US 2008/0048543 A1
(43) Pub. Date: Feb. 28, 2008

(54) Regeneration of field emission from carbon nanotubes

(76) Inventors: David S.Y. Hsu, Alexandria, VA (US); Jonathan L. Shaw, Springfield, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/229,437

(22) Filed: Sep. 14, 2005

Related U.S. Application Data
(63) Continuation of application No. 60/612,393, filed on Sep. 15, 2004.

(51) Int. Cl. H01J 1/02

(52) U.S. Cl. 313/309

(57) ABSTRACT

Large increases in field emission current can be achieved when operating carbon nanotubes in substantial pressures of hydrogen, especially when the nanotubes were contaminated. Integrally gated carbon nanotube field emitter arrays were operated without special pre-cleaning in 10⁻⁶ Torr or greater of hydrogen to produce orders of magnitude enhancement in emission. For a cNTFEA intentionally degraded by oxygen, the operation in hydrogen resulted in a 340-fold recovery in emission.

### CROSS REFERENCES TO RELATED APPLICATIONS

This application claims the benefit of U.S. Provisional Application No. 60/612393, filed Sep. 15, 2004.

### BACKGROUND OF THE INVENTION

Carbon nanotubes have become premier candidates for use as field emitters because of their large geometric field enhancement/low voltage operation, lack of electrical arcing due to the lack of a surface oxide, and robustness with certain ambient gases due to the relative chemical inertness and high work function of carbon. These combined qualities overcome many of the shortcomings of conventional metal and silicon tip field emitter arrays (FEAs). Potential applications include flat panel displays, high frequency amplifiers, spacecraft electric propulsion systems, high voltage and high temperature electronics, miniature mass spectrometers and x-ray sources, and multi-beam electron beam lithography, among others.

Previous nanotube field emission work has involved a diode configuration in which the carbon nanotubes (cNTs), either grown or placed as dense mats on substrates, were placed at a known separation (usually many tens of microns) from an anode. Although the nanotubes produce emission at very low electric fields, the operating voltages are too high for most applications (usually hundreds of volts). In order to reduce the gate voltage, multi-walled cNTs were grown inside microfabricated gates.

Two different configurations of gated cNT field emitters have been demonstrated; one consists of cNTs grown on top of gated silicon posts, see Hsu et al, Appl. Phys. Lett. 80, 188 (2002) and the second cNTs grown inside open gated apertures, see Hsu, Appl. Phys Lett 80,2988 (2002). These cNT field emitter arrays (cNTFEAs) are further described in detail in Hsu, et al, U.S. Pat. No. 6,333,598 and Hsu, U.S. Pat. Nos. 6,440,763, 6,448,701, 6,568,979, 6,590,322 and 6,890,233, herein incorporated by reference. Hsu reported that turn on-voltages below 20 volts and current densities up to 1 mA at 40 volts from a 33,000-cell array with 0.5 mm² area were measured. In addition, a high degree of robustness such as a lack of arcing, emission unaffected by xenon and high temperature, and enhancements by water vapor was reported. Also reported was a 60% increase in emission in 1.5×10⁻⁵ Torr hydrogen, in which case the cNTFEA had been carefully degassed and cleaned. In the same experiment, about a 20% emission enhancement was observed at 1×10⁻⁶ Torr hydrogen. This is in contrast to with the lack of any effect observed by Dean et. al. Appl. Phys. Lett 75, 3017 (1999) at 1×10⁻⁶ Torr H2 from their ungated single walled carbon nanotube emitter. Wadhawan et. al., Appl. Phys. Lett 79, 1867 (2001) observed no effect due to 1×10⁻⁷ Torr hydrogen on their ungated nanotubes. Bonard, Appl. Phys. Letter. 73, 918 (1998) discussed how the field emission current obtained at a given electric field or grid voltage had been degraded in uncharacterized vacuum. Studies by Dean et. al. and Wadhawan et. al. demonstrated that nanotube emission can be adversely and sensitively affected by oxygen contamination. Bonard, Dean and Wadhawan all used carbon nanotubes operated in diode mode or using macroscopic gates, which require many times higher voltages to operate compared to the gated nanotube emitters of Hsu, et al.

Since the surface of as-grown nanotubes can be in various stages of contamination, including oxygen-containing groups, there is a need in the art to provide a method to “clean up” the nanotube surface. There is a further need for methods to regain a level of emission current lost due to operation in vacuum containing trace oxygen. There is a further need for a method that can enhance and maintain a higher emission level than achievable in vacuum. There is a further need for a method to speed up emission recovery relative to operating in ultra-high vacuum. These and other needs are met by the present invention.

### BRIEF SUMMARY OF THE INVENTION

The field emission current produced by carbon nanotubes can be enhanced and/or restored by operating (emission) in a hydrogen gas ambient, at pressures preferably between approximately 10⁻⁶ and 10⁻³ torr, more preferably at approximately 10⁻⁴ torr. The beneficial effects of operating in hydrogen can be partially maintained after the hydrogen gas is removed. Operating cNTFEAs in hydrogen has been demonstrated to recover emission from even severely contaminated cNTFEAs, resulting in large enhancement factors. Operating in hydrogen can increase emitter lifetime and cost-savings. Disclosed is a method of regenerating the emission from carbon nanotube field emitters that have been degraded by exposure to surface contamination and to maintain enhanced emission by operation of hydrogen.

### BRIEF DESCRIPTION OF THE DRAWINGS

FIG. 1 shows a gated carbon nanotube-on-silicon post field emitter cell schematic

FIG. 2 shows a gated carbon nanotube-in-open aperture field emitter cell

FIG. 3 depicts the anode current-voltage characteristics of array of cNT-on-Si post emitters obtained under UHV conditions and 10⁻⁴ torr hydrogen.

FIG. 4 depicts the anode current-time plot showing regenerative effect of hydrogen on oxygen-degraded cNT-on-Si post emitters.

FIG. 5 shows the emission current-voltage characteristics from an array of 40 cells.

FIG. 6 shows the emission anode current-voltage characteristics from an array of 20 cells of the cNT-in-open aperture emitters, obtained at hydrogen pressures of 10⁻⁸ and 10⁻⁴ Torr.

### DETAILED DESCRIPTION OF THE INVENTION

CNTFEAs in both the cNT-on-Si post and the cNT-in-open aperture configurations were used in the present investigation. With the exception of some modifications to the former, the details of the fabrication were the same as those published in Hsu et al, Appl. Phys. Lett. 80, 188 (2002), J. Vac. Sci. Technol. B23, 694 (2005) and Hsu, Appl. Phys Lett 80,2988 (2002), all incorporated herein by reference. Integrally gated carbon nanotube field emitters fabricated by growing multi-walled carbon nanotubes inside pre-fabricated gate (aperature) structures were used. The height of the silicon post was reduced by isotropic etching to about 1 micron and the gate material was platinum instead of chromium. Additionally, open aperture arrays had a chromium gate. Those skilled in the art would understand that other materials could be used in the present invention.

### CNTFE Fabrication

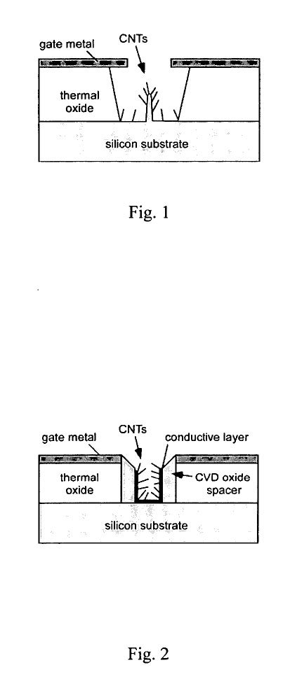

Modified Fabrication of cNT-on-Si Post: The structure and fabrication of the gated device were slightly different from those described in Hsu et al, Appl. Phys. Lett. 80, 188 (2002). Isotropic etching reduced the height and the diameter of the silicon post to about 1 micron and 0.25 micron, respectively. The gate material was platinum instead of chromium. A thin layer of Ti was sputter deposited before sputter-deposition of the Ni catalyst (˜200 A). Instead of a HF dip to lift off catalyst from the oxide regions, glancing-angle sputtering at 15° from the substrate was used to remove the catalyst from the top surfaces of the substrate. All other growth parameters were the same, including the same hot-filament assisted cold wall CVD reactor and the same temperatures and gas (ethylene and ammonia) flow rates. The resulting cell structure consisted of multi-walled nanotubes protruding from the top of the Si post in a generally random direction and is shown in FIG. 1. Only a very small fraction of the cells contained nanotubes on the Si posts in this array of 3840 cells.

Fabrication of cNT-in-Open Aperture: A cNTFEA with the open aperture design was fabricated. Open apertures were first reactive-ion-etched through chrome/silicon gates and silicon dioxide insulator on a silicon substrate. A sidewall silicon dioxide spacer was formed by conformal silicon dioxide layer deposition by CVD, followed by etch back. Fe catalyst was sputter-deposited onto the sample consisting a small array of 10 to 40 cells, followed by 15° glancing angle sputter-removal of the Fe from the top surface. Hot-filament assisted CVD was used to grow the nanotubes inside the apertures, including on the vertical sidewall spacer. FIG. 2 shows a scanning electron micrograph of such a cell.

### Emission Measurement Methods

Current-voltage emission characterization for both configurations of emitters was carried out in an UHV chamber (base pressure 10⁻¹⁰ Torr) equipped with a load lock, sample stage heater, and computerized data collection. Tungsten probes contacted the cathode (substrate) and the gate and the emission was collected on an anode probe biased at 200 V and placed about 1 mm from the sample. Hydrogen was admitted through a leak valve and dynamically pumped using an oil-free turbo-molecular pump. The gate pads of arrays of the cNT-on-Si post configuration were contacted with gold wire bonding and an anode made of a Pt mesh at 200 V bias was placed at about 2 mm from the sample. Purified hydrogen from a Pd diffusion cell was used in all the experiments.

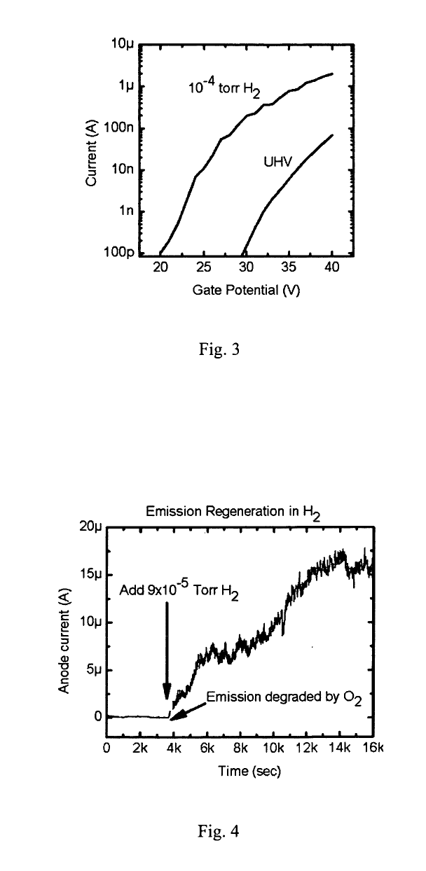

CNT-on-Si Post Emitters: FIG. 3 shows the anode current vs. gate voltage characteristics obtained first under UHV and then at 10⁻⁴ Torr of pure hydrogen from a 3840-cell array of the cNT-on Si post design as shown in FIG. 1. The array was operated in an ion pumped UHV chamber for many hours before the UHV data were taken. Exposure to hydrogen increased the emission current by orders of magnitude and reduced the apparent “turn-on” voltage by 30%.

A separate array with the same number of cells was run overnight in a turbo-pumped chamber under a continuous flow of 1×10⁻⁷ Torr oxygen at a constant gate voltage of 50 V until the emission degraded to about 44 nA. The effect of the addition of a continuous flow of hydrogen at 9×10⁻⁵ Torr is shown in the anode current-time plot in FIG. 4. A sharp increase in emission is followed by a gradual increase until stabilizing at 15 μA after about 2.8 hr, with an overall recovery factor of 340.

These results suggest that operation in oxygen did not significantly consume the nanotubes through reaction with oxygen to form CO or CO2 gas. Instead, the emission degradation was likely due to surface contamination with oxygen, which was removed by reaction with hydrogen atoms. Exposure of the emitters to molecular hydrogen or oxygen when the arrays were not emitting had no effect on the emission produced once the gases are removed. The fact that the emission characteristics do not change when exposed to gases unless field emission is taking place suggests that the nanotubes are inert to the molecular forms of hydrogen and oxygen and that the atomic forms, which are created by electron dissociation, react with surface groups either in removal or attachment processes.

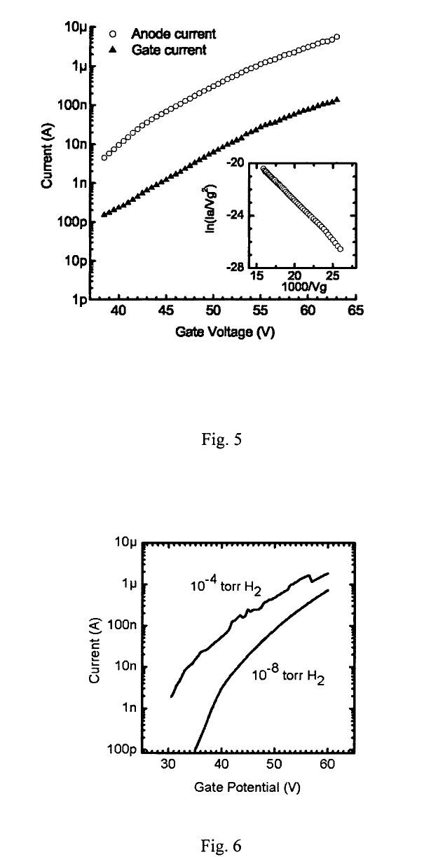

CNT-in-Open Aperture Emitters: CNT-in-Open aperture emitters have achieved the lowest gate current to anode current ratio (2.5%) of any nanotube emitters to date. The results from a 40-cell array taken under UHV conditions are reproduced in FIG. 5. The FIG. 5 inset shows a Fowler-Nordheim plot of the anode current, the linearity of which indicates well-behaved field emission.

FIG. 6 compares the emission anode current from an array of 20 cells obtained under hydrogen pressures of 1×10⁻⁸ and 1×10⁻⁴ Torr in the UHV chamber. A large emission increase, of approximately a factor of 10 at 45 volts, at the higher pressure was observed. The saturation behavior at higher voltages could be due to faster hydrogen desorption at the higher currents.

Significant changes in the emission current for hydrogen pressures below 1×10⁻⁵ torr were not observed. The effect increased with pressure up to about 10⁻⁴ torr, and stayed the same at higher pressures. The emission began to decrease as soon as the hydrogen was removed but some effect remained for several hours after the hydrogen was removed.

The requirement for relatively high pressures (>10⁻⁶ Torr) of hydrogen again suggests that atomic hydrogen is responsible for the large enhancement and regeneration effects and that atomic hydrogen is created by electron impact from the operating emitters. The production rate of atomic hydrogen is apparently too low at lower pressures.

The effect of the atomic hydrogen may be any or all of the following mechanisms a) chemical removal of oxygen-containing surface species (which may act as p-type dopants and/or increase the work function), b) formation of a surface dipole (reducing the work function), and c) n-type doping by atomic hydrogen.

The results suggest that these beneficial hydrogen-nanotube interaction processes could also be accomplished and speeded up by exposing the emitters to an external source of hydrogen atoms. The inclusion of hydrogen at appropriate pressures (so not to affect electron mean free-path) in devices that use cNT emitters can enhance emitter lifetime and result in large cost-savings.

The hydrogen can be provided by an any source known in the art. Some examples include, but are not limited to using a hot filament operating in the presence of hydrogen or using hydrogen plasma. Another source could be a positively-biased structures, such as gate and anode, that have a large capacity for adsorbing hydrogen. Reactive forms of hydrogen, such as atoms and ions, can be produced by electron impact on the adsorbed hydrogen on the positively-biased structures. Further, positively-biased structures that can catalytically dissociate hydrogen can likewise produce reactive forms of hydrogen by electron impact on the hydrogen dissociated on the structures. Additionally, hydrogen can be released when needed where hydrogen is pre-adsorbed on a getter material and the getter material is activated when the hydrogen is needed. Another potential source of hydrogen is a positively-biased structure containing chemically-bonded hydrogen or dissolved hydrogen, which produces hydrogen by electron impact on said structure. The chemically-bonded hydrogen could be, for example, a metal hydride.

The above description is that of a preferred embodiment of the invention. Various modifications and variations are possible in light of the above teachings. It is therefore to be understood that, within the scope of the appended claims, the invention may be practiced otherwise than as specifically described. Any reference to claim elements in the singular, e.g. using the articles “a,” “an,” “the,” or “said” is not construed as limiting the element to the singular.

1. A method of increasing the emission level from carbon nanotube field emitters, comprising:
providing a carbon nanotube field emitter; and
operating said carbon nanotube field emitter in hydrogen.

2. The method of claim 1 wherein said hydrogen ranges preferably between 10⁻⁶ and 10⁻³ torr.

3. The method of claim 2 wherein said hydrogen is most preferably about 10⁻⁴ torr.

4. A method of restoring a level of emission from a carbon nanotube field emitter that has been degraded by contamination, comprising:
providing a carbon nanotube field emitter, and
operating said carbon nanotube field emitter in hydrogen.

5. The method of claim 4 wherein said hydrogen ranges preferably between 10⁻⁶ and 10⁻³ torr.

6. The method of claim 5 wherein said hydrogen is most preferably about 10⁻⁴ torr.

7. A method of decreasing the emission recovery time of a carbon nanotube field emitter, comprising:
providing a carbon nanotube field emitter, and
exposing said carbon nanotube field emitter to a source of reactive forms of hydrogen.

8. A carbon nanotube field emitter having an increased emission level, comprising:
a carbon nanotube field emitter; and
a source of hydrogen, wherein said field emitter is operated in the hydrogen.

9. The carbon nanotube field emitter of claim 8, wherein said hydrogen is provided by an external source of hydrogen atoms and ions.

10. The carbon nanotube field emitter of claim 9, wherein said external source is a hot filament operating in the presence of hydrogen.

11. The carbon nanotube field emitter of claim 9, wherein said external source of hydrogen is a hydrogen plasma.

12. The carbon nanotube field emitter of claim 8 wherein said source of hydrogen comprises:
at least one positively-biased structure having a large capacity for adsorbing hydrogen,
wherein hydrogen molecules, atoms and ions are produced by electron impact on said hydrogen adsorbed on said structure.

13. The carbon nanotube field emitter of claim 8 wherein said source of hydrogen comprises:
at least one positively-biased structure capable of catalytically dissociating hydrogen,
wherein hydrogen atoms and ions are produced by electron impact on said hydrogen dissociated on said structure.

14. The carbon nanotube field emitter of claim 8 wherein said source of hydrogen is a getter material having hydrogen pre-adsorbed on said getter material said hydrogen being released when said getter material is activated.

15. The carbon nanotube field emitter of claim 8 wherein said source of hydrogen comprises:
at least one positively-biased structure containing chemically-bonded hydrogen or dissolved hydrogen, wherein said hydrogen is produced by electron impact on said structure.

16. A carbon nanotube field emitter having reduced emission recovery time, comprising:
a carbon nanotube field emitter; and
a source of hydrogen, wherein said field emitter is exposed to a form of reactive hydrogen.

17. The carbon nanotube field emitter of claim 16, wherein said hydrogen is provided by an external source of hydrogen atoms and ions.

18. The carbon nanotube field emitter of claim 17, wherein said external source is a hot filament operating in the presence of hydrogen.

19. The carbon nanotube field emitter of claim 17, wherein said external source of hydrogen is a hydrogen plasma.

20. The carbon nanotube field emitter of claim 16 wherein said source of hydrogen comprises:
at least one positively-biased structure having a large capacity for adsorbing hydrogen,
wherein hydrogen molecules, atoms and ions are produced by electron impact on said hydrogen adsorbed on said structure.

21. The carbon nanotube field emitter of claim 16 wherein said source of hydrogen comprises:
at least one positively-biased structure capable of catalytically dissociating hydrogen,
wherein hydrogen atoms and ions are produced by electron impact on said hydrogen dissociated on said structure.

22. The carbon nanotube field emitter of claim 16 wherein said source of hydrogen is a getter material having hydrogen pre-adsorbed on said getter material, said hydrogen being released when said getter material is activated.

23. The carbon nanotube field emitter of claim 16 wherein said source of hydrogen comprises:
at least one positively-biased structure containing chemically-bonded hydrogen or dissolved hydrogen, wherein said hydrogen is produced by electron impact on said structure.
